(19) United States
(12) Patent Application Publication
(10) Pub. No.: US 2013/0265117 A1
(43) Pub. Date: Oct. 10, 2013

(54) RF AND HIGH-SPEED DATA CABLE

(71) Applicants: Stanley Yu Tao Ng, Bellevue, WA (US); Alireza Mahanfar, Bellevue, WA (US); Kim Schulze, Seattle, WA (US)

(72) Inventors: Stanley Yu Tao Ng, Bellevue, WA (US); Alireza Mahanfar, Bellevue, WA (US); Kim Schulze, Seattle, WA (US)

(21) Appl. No.: 13/441,625

(22) Filed: Apr. 6, 2012

(51) Int. Cl. H01P 5/10

(52) U.S. Cl. 333/26

(57) ABSTRACT

A cable is disclosed for transmitting high speed digital baseband signals together with analog RF signals between first and second components. The RF signals may be transmitted between an antenna in the first component and an RF transceiver in the second component at operating frequencies such as for example 70 MHz to 6 GHz. In order to reduce cross-talk between the digital and analog lines, the analog signal may be carried over a line including a pair of wires such as a differential signal pair. The pair of wires carrying the analog signal may include baluns at either end to enable delivery over the pair of wires. The baluns may be wideband baluns to support communication over the full range of operating frequencies. In order to further reduce cross-talk, the digital and/or analog lines may be encased within an EMI-absorbing jacket made of extruded ferrite as one example.

### BACKGROUND

In a distributed antenna system utilizing an antenna remote from a radio frequency transceiver, it is known to use a cable to transmit data between the two end points over a digital connection and a separate radio frequency (RF) connection. In such cables, it is important to isolate the RF connection from noise, for example from the digital connection, in order to provide the desired receiver sensitivity performance. Such isolation is manageable using conventional techniques where the digital signal is transmitted at lower frequencies, such as for example lower than 500 MHz. However, some digital technologies including for example USB3.0, SATA, Display Port perform digital communication at higher frequencies, for example greater than 1 GHz. Conventional techniques are not as effective at filtering noise from the RF connection at these higher frequencies.

### SUMMARY

The present technology relates to a cable which in embodiments is capable of transmitting high speed digital signals together with analog RF signals between first and second components. The RF signals may be transmitted between an antenna in the first component and an RF transceiver in the second component at operating frequencies such as for example 700 MHz to 6 GHz. In order to provide adequate signal integrity and EMI performance at these operating frequencies, the analog RF signal is split into complementary signals and carried over a line including a pair of wires such as a differential signal pair. The pair of wires carrying the RF signal may include baluns at either end to enable delivery over the pair of wires. The baluns may be wideband baluns to support communication over the full range of operating frequencies.

In order to provide further noise reduction and cross-talk between the digital and analog lines, the digital and/or analog lines may be encased within an EMI-absorbing jacket made of ferrite for example. The ferrite jacket may be extruded over the entire length of the digital and/or analog lines, though it may be formed over the lines as a film or braided jacket in further examples. Carrying the RF signals over a pair of differential lines, and encasing the digital and/or RF lines in a ferrite jacket, allows significant noise isolation.

In one example, the present technology relates to a cable for transferring digital and analog signals between a first component including a transceiver and a second component including an antenna, the second component remote from the first component, the cable comprising: a pair of digital lines for carrying digital baseband signals between the first and second components; an analog line for carrying signals between the antenna and the transceiver at operating frequencies between 700 MHz and 6 GHz, the analog line including a pair of wires carrying analog signals; and a pair of wideband baluns, coupled to ends of the analog line, for transforming the signals to enable delivery over the pair of wires of the analog line, the wideband baluns capable of transforming the signals over the operating frequencies between 700 MHz and 6 GHz.

In a further example, the present technology relates to a cable for transferring digital and analog signals between a first component including an RF transceiver and a second component including an antenna, the second component spatially separated from the first component, the cable comprising: a pair of digital lines for carrying digital signals between the first and second components, a first digital line of the pair of digital lines carrying signals from the first component to the second component, and a second digital line of the pair of digital lines carrying signals from the second component to the first component; an RF line for carrying RF signals between the antenna and the RF transceiver at operating frequencies between 700 MHz and 6 GHz, the analog line including a differential pair of signal wires carrying analog signals, the RF line encased in an electromagnetic interference-absorbing jacket; and a pair of wideband baluns, coupled to ends of the RF line, for transforming the signals to enable delivery over the differential pair of signal wires, the wideband baluns capable of transforming the signals over the operating frequencies between 700 MHz and 6 GHz.

In another example, the present technology relates to a cable for transferring digital and analog signals between a processing unit including an RF transceiver and a head mounted display device including an antenna in a see-through augmented reality system, the processing unit spatially separated from the head mounted display device, the cable comprising: a pair of digital lines for carrying digital baseband signals between the processing unit and the head mounted display device, a first digital line of the pair of digital lines carrying signals from the processing unit to the head mounted display device, and a second digital line of the pair of digital lines carrying signals from the head mounted display device to the processing unit, the pair of digital lines encased in ferrite jackets; an RF line for carrying RF signals between the antenna and the RF transceiver at operating frequencies between 700 MHz and 6 GHz, the analog line including a differential pair of signal wires carrying common mode analog signals, the RF line encased in a ferrite jacket; and a pair of wideband baluns, coupled to ends of the RF line, for transforming the signals to enable delivery over the differential pair of signal wires, the wideband baluns capable of transforming the signals over the operating frequencies between 700 MHz and 6 GHz.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram depicting a cable and other example components used in a see-through augmented reality display device system.

FIG. 2A is a side view of an eyeglass temple of the frame in an embodiment of the see-through augmented reality display device embodied as eyeglasses providing support for the hardware and software components.

FIG. 2B is a top view of an embodiment of a display optical system of the see-through augmented reality device.

FIG. 3A is a block diagram of one embodiment of the hardware and software components of the see-through augmented reality display device as may be used with one or more embodiments.

FIG. 3B is a block diagram describing the various components of a processing unit.

FIG. 4 is a generalized block diagram of a cable for transmitting high-speed digital signals and analog RF signals between the first and second components.

FIG. 5 is a cross-section of the cable shown in FIG. 4.

### DETAILED DESCRIPTION

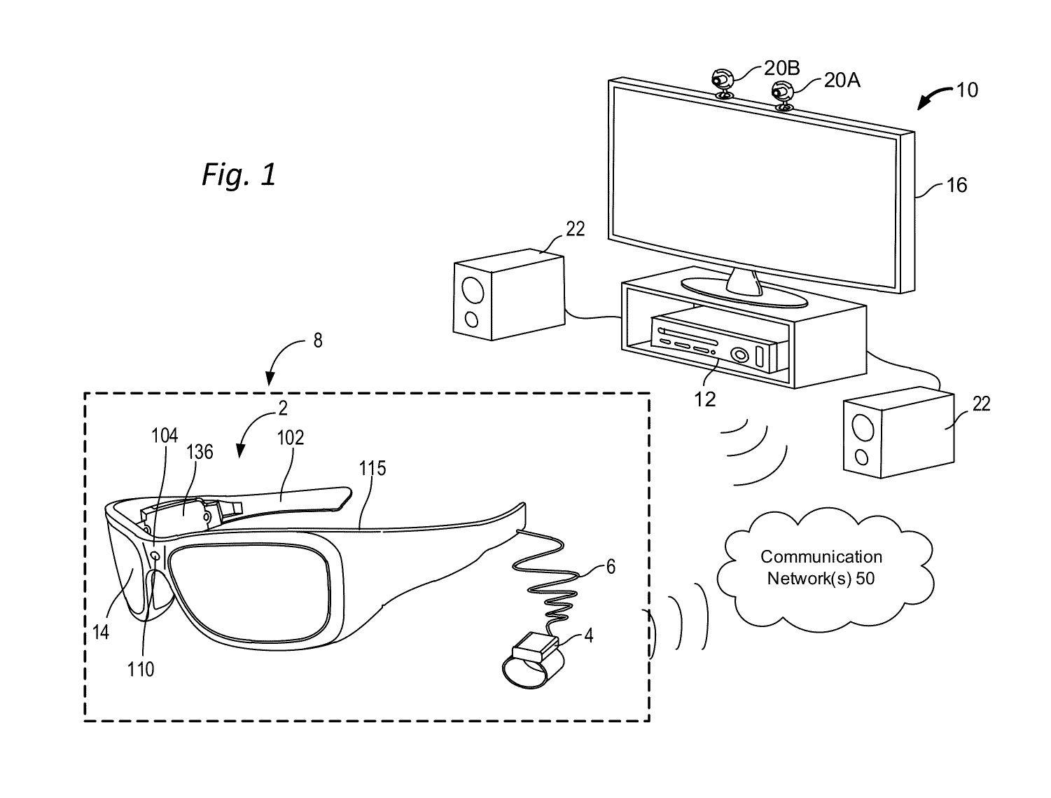

Embodiments of the present technology will now be described with reference to FIGS. 1-5, which in general relate to an RF and high-speed digital cable where the RF line is shielded against cross-talk from the high-speed digital lines and other sources. In general, the cable includes two shielded differential pair (“SDP”) lines for carrying high-speed digital signals between the first and second components connected by the cable. The first SDP high-speed line carries digital signals from the first component to the second component, and the second SDP high-speed line carries digital signals from the second component to the first component.

The cable further includes a third line for carrying analog RF signals between a transceiver in the first component and an antenna in the second component. In order to reduce noise in the third line, it may be provided as an SDP line where noise and spurious electromagnetic waves in the respective wires cancel each other in the line. Furthermore, the RF line is jacketed with a ferrite extrusion which absorbs noise and EMI emanating from the pair of high-speed digital lines and other sources.

As explained below, in embodiments, the cable of the present technology may be used in a see-through augmented reality system where the first and second components are a head mounted display unit coupled by the cable to a processing unit worn or carried by the user. The antenna may for example be in the head mounted display for receiving and transmitting a variety of analog signals. However, the cable of the present technology may be used in a variety of other applications for carrying both high-speed digital signals and high-frequency analog signals between a pair of components coupled by the cable.

Referring now to FIG. 1, there is shown an example of a cable according to the present technology used in a see-through augmented reality system 8. System 8 includes a see-through display device as a near-eye, head mounted display device 2 in communication with processing unit 4 via a cable 6 according to the present technology. Further details regarding cable 6 are provided below. Processing unit 4 may take various embodiments. In some embodiments, processing unit 4 is a separate unit which may be worn on the user's body, e.g. the wrist in the illustrated example or in a pocket, and includes much of the computing power used to operate near-eye display device 2. Processing unit 4 may communicate wirelessly (e.g., WiFi, Bluetooth, infra-red, wireless Universal Serial Bus (WUSB), cellular, 3G, 4G or other wireless communication means) over a communication network 50 to one or more hub computing systems 12 whether located nearby as in this example or at a remote location. In other embodiments, the functionality of the processing unit 4 may be integrated in the software and hardware components of the display device 2.

Head mounted display device 2, which in one embodiment is in the shape of eyeglasses in a frame 115, is worn on the head of a user so that the user can see through a display, embodied in this example as a display optical system 14 for each eye, and thereby have an actual direct view of the space in front of the user.

The use of the term “actual direct view” refers to the ability to see real world objects directly with the human eye, rather than seeing created image representations of the objects. For example, looking through glass at a room allows a user to have an actual direct view of the room, while viewing a video of a room on a television is not an actual direct view of the room. Based on the context of executing software, for example, a gaming application, the system can project images of virtual objects, sometimes referred to as virtual images, on the display that are viewable by the person wearing the see-through display device while that person is also viewing real world objects through the display.

Frame 115 provides a support for holding elements of the system in place as well as a conduit for electrical connections. In this embodiment, frame 115 provides a convenient eyeglass frame as support for the elements of the system discussed further below. In other embodiments, other support structures can be used. Examples of such a structure are a visor or goggles. The frame 115 includes a temple or side arm for resting on each of a user's ears. Temple 102 is representative of an embodiment of the right temple and includes control circuitry 136 for the display device 2. Nose bridge 104 of the frame includes a microphone 110 for recording sounds and transmitting audio data to processing unit 4.

Hub computing system 12 may be a computer, a gaming system or console, or a combination of one or more of these. According to an example embodiment, the hub computing system 12 may include hardware components and/or software components such that hub computing system 12 may be used to execute applications such as gaming applications, non-gaming applications, or the like. An application may be executing on hub computing system 12, or by one or more processors of the see-through mixed reality system 8.

In this embodiment, hub computing system 12 is communicatively coupled to one or more capture devices, such as capture devices 20A and 20B. In other embodiments, more or less than two capture devices can be used to capture the room or other physical environment of the user.

Capture devices 20A and 20B may be, for example, cameras that visually monitor one or more users and the surrounding space such that gestures and/or movements performed by the one or more users, as well as the structure of the surrounding space, may be captured, analyzed, and tracked to perform one or more controls or actions within an application and/or animate an avatar or on-screen character. Each capture device, 20A and 20B, may also include a microphone (not shown). Hub computing system 12 may be connected to an audiovisual device 16 such as a television, a monitor, a high-definition television (HDTV), or the like that may provide game or application visuals. In some instances, the audiovisual device 16 may be a three-dimensional display device. In one example, audiovisual device 16 includes internal speakers. In other embodiments, audiovisual device 16, a separate stereo or hub computing system 12 is connected to external speakers 22.

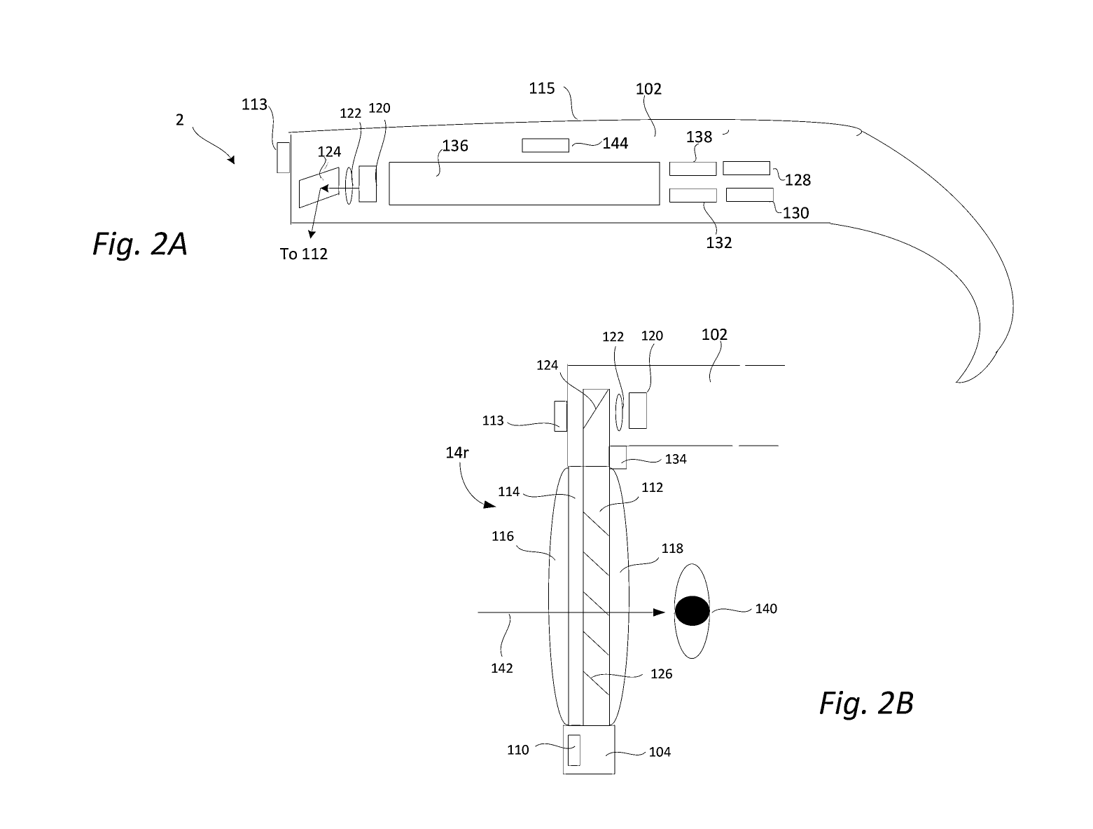

FIG. 2A is a side view of an eyeglass temple 102 of the frame 115 in an embodiment of the see-through, mixed reality display device embodied as eyeglasses providing support for hardware and software components. At the front of frame 115 is physical environment facing video camera 113 that can capture video and still images which are transmitted to the processing unit 4. Particularly in some embodiments where the display device 2 is not operating in conjunction with depth cameras like capture devices 20A and 20B of the hub system 12, the physical environment facing camera 113 may be a depth camera as well as a visible light sensitive camera. For example, the depth camera may include an IR illuminator transmitter and a hot reflecting surface like a hot mirror in front of the visible image sensor which lets the visible light pass and directs reflected IR radiation within a wavelength range or about a predetermined wavelength transmitted by the illuminator to a CCD or other type of depth sensor. Other examples of detectors that may be included on the head mounted display device 2 without limitation, are SONAR, LIDAR, Structured Light, and/or Time of Flight distance detectors positioned to detect information that a wearer of the device may be viewing.

The data from the camera may be sent to a processor 210 of the control circuitry 136, or the processing unit 4, or both, which may process them but which the unit 4 may also send to one or more computer systems 12 over a network 50 for processing. The processing identifies and maps the user's real world field of view. Additionally, the physical environment facing camera 113 may also include a light meter for measuring ambient light.

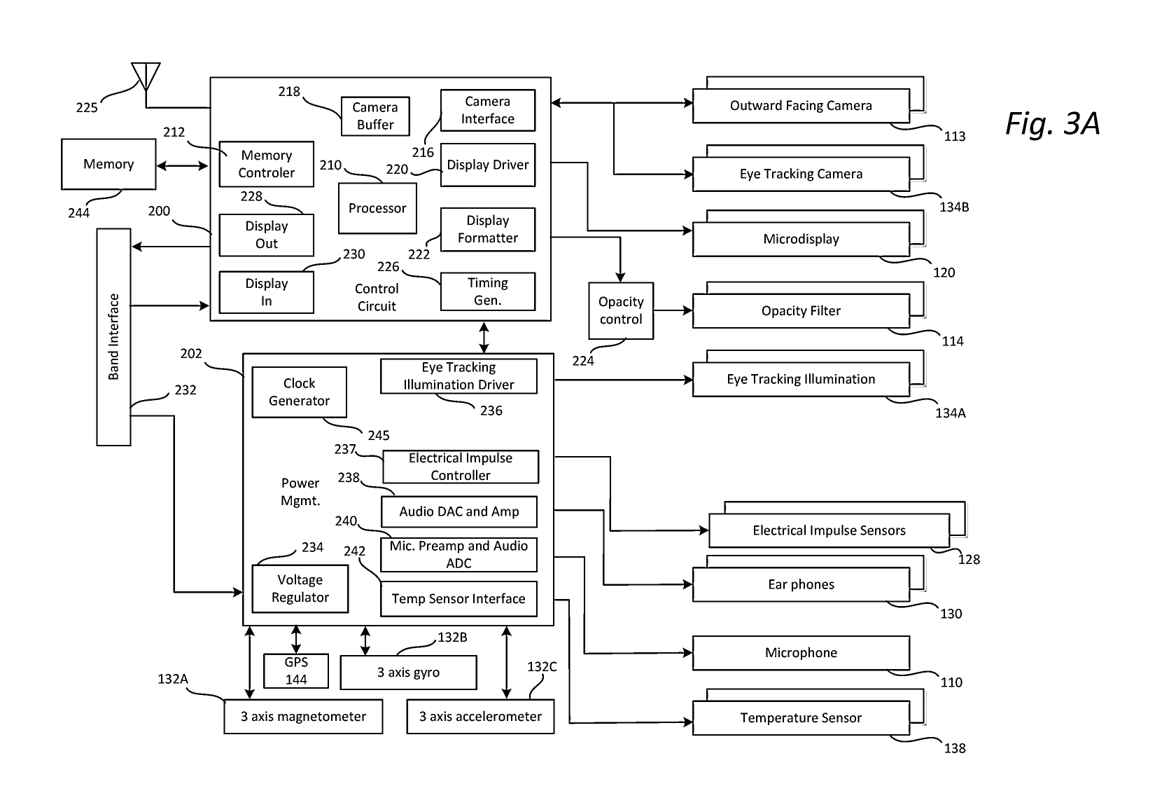

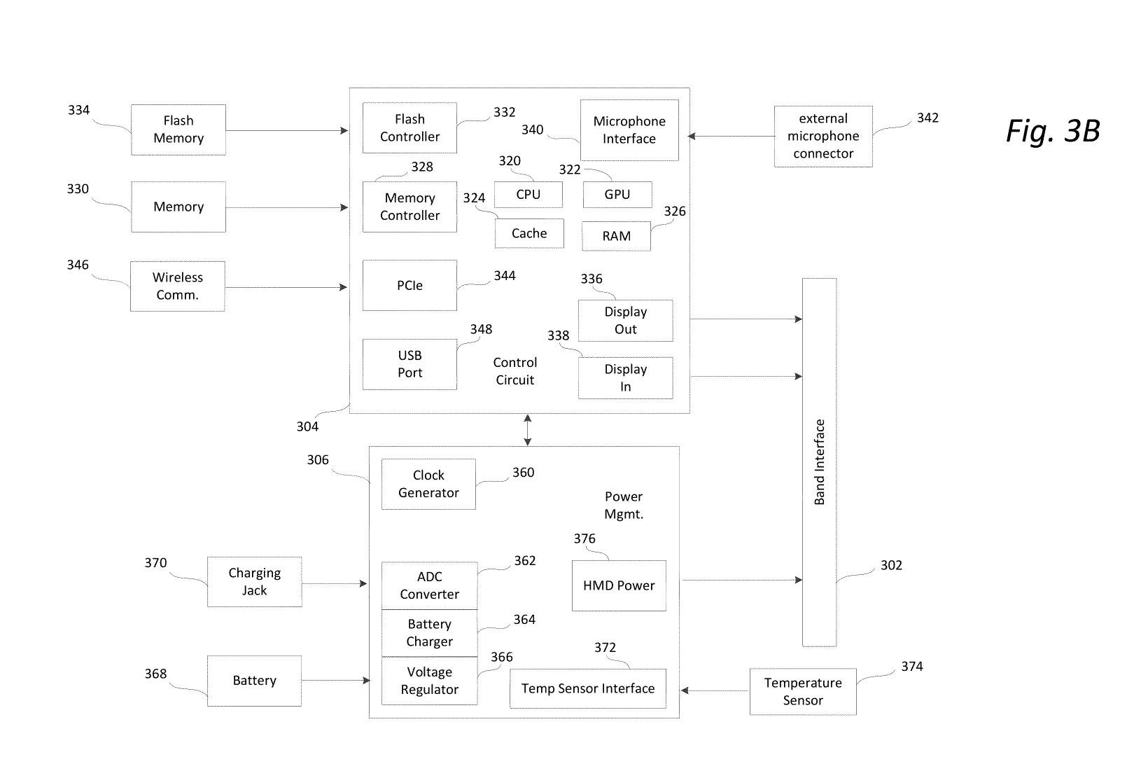

Control circuits 136 provide various electronics that support the other components of head mounted display device 2. More details of control circuits 136 are provided below with respect to FIG. 3A. Inside, or mounted to temple 102, are ear phones 130, inertial sensors 132, GPS transceiver 144 and temperature sensor 138. In one embodiment, inertial sensors 132 include a three axis magnetometer 132A, three axis gyro 132B and three axis accelerometer 132C (See FIG. 3A). The inertial sensors are for sensing position, orientation, and sudden accelerations of head mounted display device 2. From these movements, head position may also be determined.

Mounted to or inside temple 102 is an image source or image generation unit. In one embodiment, the image source includes micro display assembly 120 for projecting images of one or more virtual objects and lens system 122 for directing images from micro display 120 into light guide optical element 112. Lens system 122 may include one or more lenses. In one embodiment, lens system 122 includes one or more collimating lenses. In the illustrated example, a reflecting element 124 of light guide optical element 112 receives the images directed by the lens system 122.

There are different image generation technologies that can be used to implement micro display 120. For example, micro display 120 can be implemented using a transmissive projection technology where the light source is modulated by optically active material, backlit with white light. These technologies are usually implemented using LCD type displays with powerful backlights and high optical energy densities. Micro display 120 can also be implemented using a reflective technology for which external light is reflected and modulated by an optically active material. Digital light processing (DGP), liquid crystal on silicon (LCOS) and Mirasol® display technology from Qualcomm, Inc. are all examples of reflective technologies. Additionally, micro display 120 can be implemented using an emissive technology where light is generated by the display, see for example, a PicoP™ display engine from Microvision, Inc.

FIG. 2B is a top view of an embodiment of a display optical system 14 of a see-through, near-eye, augmented or mixed reality device. A portion of the frame 115 of the near-eye display device 2 will surround a display optical system 14 for providing support for one or more lenses as illustrated and making electrical connections. In order to show the components of the display optical system 14, in this case 14r for the right eye system, in the head mounted display device 2, a portion of the frame 115 surrounding the display optical system is not depicted.

In one embodiment, the display optical system 14 includes a light guide optical element 112, opacity filter 114, see-through lens 116 and see-through lens 118. In one embodiment, opacity filter 114 is behind and aligned with see-through lens 116, light guide optical element 112 is behind and aligned with opacity filter 114, and see-through lens 118 is behind and aligned with light guide optical element 112. See-through lenses 116 and 118 are standard lenses used in eye glasses and can be made to any prescription (including no prescription). In one embodiment, see-through lenses 116 and 118 can be replaced by a variable prescription lens. In some embodiments, head mounted display device 2 will include only one see-through lens or no see-through lenses. In another alternative, a prescription lens can go inside light guide optical element 112. Opacity filter 114 filters out natural light (either on a per pixel basis or uniformly) to enhance the contrast of the virtual imagery. Light guide optical element 112 channels artificial light to the eye. More details of the opacity filter 114 and light guide optical element 112 are provided below. In alternative embodiments, an opacity filter 114 may not be utilized.

Light guide optical element 112 transmits light from micro display 120 to the eye 140 of the user wearing head mounted display device 2. Light guide optical element 112 also allows light from in front of the head mounted display device 2 to be transmitted through light guide optical element 112 to eye 140, as depicted by arrow 142 representing an optical axis of the display optical system 14r, thereby allowing the user to have an actual direct view of the space in front of head mounted display device 2 in addition to receiving a virtual image from micro display 120. Thus, the walls of light guide optical element 112 are see-through. Light guide optical element 112 includes a first reflecting element 124 (e.g., a mirror or other surface). Light from micro display 120 passes through lens system 122 and becomes incident on reflecting element 124. The reflecting element 124 reflects the incident light from the micro display 120 such that the light is trapped inside a planar substrate comprising light guide optical element 112 by internal reflection.

After several reflections off the surfaces of the substrate, the trapped light waves reach an array of selectively reflecting surfaces 126. Note that only one of the five surfaces is labeled 126 to prevent over-crowding of the drawing. Reflecting surfaces 126 couple the light waves incident upon those reflecting surfaces out of the substrate into the eye 140 of the user. In one embodiment, each eye will have its own light guide optical element 112. When the head mounted display device has two light guide optical elements, each eye can have its own micro display 120 that can display the same image in both eyes or different images in the two eyes. In another embodiment, there can be one light guide optical element which reflects light into both eyes.

Opacity filter 114, which is aligned with light guide optical element 112, selectively blocks natural light, either uniformly or on a per-pixel basis, from passing through light guide optical element 112. In one embodiment, the opacity filter can be a see-through LCD panel, electro chromic film, or similar device which is capable of serving as an opacity filter. Such a see-through LCD panel can be obtained by removing various layers of substrate, backlight and diffusers from a conventional LCD. The LCD panel can include one or more light-transmissive LCD chips which allow light to pass through the liquid crystal. Such chips are used in LCD projectors, for instance.

Opacity filter 114 can include a dense grid of pixels, where the light transmissivity of each pixel is individually controllable between minimum and maximum transmissivities. While a transmissivity range of 0-100% is ideal, more limited ranges are also acceptable. In one example, 100% transmissivity represents a perfectly clear lens. An “alpha” scale can be defined from 0-100%, where 0% allows no light to pass and 100% allows all light to pass. The value of alpha can be set for each pixel by the opacity filter control unit 224 described below.

A mask of alpha values can be used from a rendering pipeline, after z-buffering with proxies for real-world objects. When the system renders a scene for the see-through augmented reality display, it takes note of which real-world objects are in front of which virtual objects. If a virtual object is in front of a real-world object, then the opacity should be on for the coverage area of the virtual object. If the virtual object is (virtually) behind a real-world object, then the opacity should be off, as well as any color for that pixel, so the user will only see the real-world object for that corresponding area (a pixel or more in size) of real light. Coverage would be on a pixel-by-pixel basis, so the system could handle the case of part of a virtual object being in front of a real-world object, part of the virtual object being behind the real-world object, and part of the virtual object being coincident with the real-world object. Displays capable of going from 0% to 100% opacity at low cost, power, and weight are the most desirable for this use. Moreover, the opacity filter can be rendered in color, such as with a color LCD or with other displays such as organic LEDs, to provide a wide field of view. More details of an opacity filter are provided in U.S. patent application Ser. No. 12/887,426, entitled “Opacity Filter For See-Through Mounted Display,” filed on Sep. 21, 2010, incorporated herein by reference in its entirety.

In one embodiment, the display and the opacity filter are rendered simultaneously and are calibrated to a user's precise position in space to compensate for angle-offset issues. Eye tracking can be employed to compute the correct image offset at the extremities of the viewing field. In some embodiments, a temporal or spatial fade in the amount of opacity can be used in the opacity filter. Similarly, a temporal or spatial fade in the virtual image can be used. In one approach, a temporal fade in the amount of opacity of the opacity filter corresponds to a temporal fade in the virtual image. In another approach, a spatial fade in the amount of opacity of the opacity filter corresponds to a spatial fade in the virtual image.

In one example approach, an increased opacity is provided for the pixels of the opacity filter which are behind the virtual image, from the perspective of the identified location of the user's eyes. In this manner, the pixels behind the virtual image are darkened so that light from a corresponding portion of the real world scene is blocked from reaching the user's eyes. This allows the virtual image to be realistic and represent a full range of colors and intensities. Moreover, power consumption by the see-through augmented reality emitter is reduced since the virtual image can be provided at a lower intensity. Without the opacity filter, the virtual image would need to be provided at a sufficiently high intensity which is brighter than the corresponding portion of the real world scene, for the virtual image to be distinct and not transparent. In darkening the pixels of the opacity filter, generally, the pixels which follow the closed perimeter of the virtual image are darkened, along with pixels within the perimeter. It can be desirable to provide some overlap so that some pixels which are just outside the perimeter and surround the perimeter are also darkened (at the same level of darkness or less dark than pixels inside the perimeter). These pixels just outside the perimeter can provide a fade (e.g., a gradual transition in opacity) from the darkness inside the perimeter to the full amount of opacity outside the perimeter.

Head mounted display device 2 also includes a system for tracking the position of the user's eyes. The system will track the user's position and orientation so that the system can determine the field of view of the user. However, a human will not perceive everything in front of them. Instead, a user's eyes will be directed at a subset of the environment. Therefore, in one embodiment, the system will include technology for tracking the position of the user's eyes in order to refine the measurement of the field of view of the user. For example, head mounted display device 2 includes eye tracking assembly 134 (see FIG. 2B), which will include an eye tracking illumination device 134A and eye tracking camera 134B (see FIG. 3A).

In one embodiment, eye tracking illumination source 134A includes one or more infrared (IR) emitters, which emit IR light toward the eye. Eye tracking camera 134B includes one or more cameras that sense the reflected IR light. The position of the pupil can be identified by known imaging techniques which detect the reflection of the cornea. For example, see U.S. Pat. No. 7,401,920, entitled “Head Mounted Eye Tracking and Display System”, issued on Jul. 22, 2008 to Kranz et al., incorporated herein by reference. Such a technique can locate a position of the center of the eye relative to the tracking camera. Generally, eye tracking involves obtaining an image of the eye and using computer vision techniques to determine the location of the pupil within the eye socket. In one embodiment, it is sufficient to track the location of one eye since the eyes usually move in unison. However, it is possible to track each eye separately. Alternatively, the eye tracking camera may be an alternative form of a tracking camera using any motion based image of the eye to detect position, with or without an illumination source.

In one embodiment, the instructions may comprise looking up detected objects in the image data in a database including relationships between the user and the object, and the relationship being associated in data with one or more state of being data settings. Other instruction logic such as heuristic algorithms may be applied to determine a state of being of the user based on both the eye data and the image data of the user's surroundings.

FIGS. 2A and 2B only show half of the head mounted display device 2. A full head mounted display device would include another set of see-through lenses 116 and 118, another opacity filter 114, another light guide optical element 112, another micro display 120, another lens system 122, another physical environment facing camera 113 (also referred to as outward facing or front facing camera 113), another eye tracking assembly 134, another earphone 130, another set of sensors 128 if present and temperature sensor 138. Additional details of a head mounted display 2 are illustrated in U.S. patent application Ser. No. 12/905,952 entitled “Fusing Virtual Content Into Real Content,” filed on Oct. 15, 2010, fully incorporated herein by reference.

FIG. 3A is a block diagram of one embodiment of hardware and software components of a see-through, near-eye, mixed reality display device 2 as may be used with one or more embodiments. FIG. 3B is a block diagram describing the various components of a processing unit 4. In this embodiment, near-eye display device 2, receives instructions about a virtual image from processing unit 4 via cable 6 and provides data from sensors back to processing unit 4 via cable 6. Software and hardware components which may be embodied in a processing unit 4, for example as depicted in FIG. 3B, receive the sensory data from the display device 2 and may also receive sensory information from a computing system 12 over a network 50 (See FIGS. 1A and 1B). Based on that information, processing unit 4 will determine where and when to provide a virtual image to the user and send instructions accordingly to the control circuitry 136 of the display device 2.

Note that some of the components of FIG. 3A (e.g., outward or physical environment facing camera 113, eye tracking assembly 134, micro display 120, opacity filter 114, eye tracking illumination unit 134A, earphones 130, sensors 128 if present, and temperature sensor 138) are shown in shadow to indicate that there are at least two of each of those devices, at least one for the left side and at least one for the right side of head mounted display device 2. FIG. 3A shows the control circuit 200 in communication with the power management circuit 202. Control circuit 200 includes processor 210, memory controller 212 in communication with memory 244 (e.g., D-RAM), camera interface 216, camera buffer 218, display driver 220, display formatter 222, timing generator 226, display out interface 228, and display in interface 230. In one embodiment, all of the components of control circuit 200 are in communication with each other via dedicated lines of one or more buses. In another embodiment, each of the components of control circuit 200 are in communication with processor 210. Head mounted display device 2 may further include an antenna 225 for sending and receiving RF signals as explained in greater detail below.

Camera interface 216 provides an interface to the two physical environment facing cameras 113 and each eye tracking assembly 134 and stores respective images received from the cameras 113, 134 in camera buffer 218. Display driver 220 will drive microdisplay 120. Display formatter 222 may provide information, about the virtual image being displayed on microdisplay 120 to one or more processors of one or more computer systems, e.g. 4, 12, 210 performing processing for the see-through augmented reality system. The display formatter 222 can identify to the opacity control unit 224 transmissivity settings for pixels of the display optical system 14. Timing generator 226 is used to provide timing data for the system. Display out interface 228 includes a buffer for providing images from physical environment facing cameras 113 and the eye cameras 134 to the processing unit 4. Display in interface 230 includes a buffer for receiving images such as a virtual image to be displayed on microdisplay 120. Display out 228 and display in 230 communicate with band interface 232 which is an interface to processing unit 4.

Power management circuit 202 includes voltage regulator 234, eye tracking illumination driver 236, audio DAC and amplifier 238, microphone preamplifier and audio ADC 240, temperature sensor interface 242, electrical impulse controller 237, and clock generator 245. Voltage regulator 234 receives power from processing unit 4 via band interface 232 and provides that power to the other components of head mounted display device 2. Illumination driver 236 controls, for example via a drive current or voltage, the eye tracking illumination unit 134A to operate about a predetermined wavelength or within a wavelength range. Audio DAC and amplifier 238 provides audio data to earphones 130. Microphone preamplifier and audio ADC 240 provides an interface for microphone 110. Temperature sensor interface 242 is an interface for temperature sensor 138. Electrical impulse controller 237 receives data indicating eye movements from the sensor 128 if implemented by the display device 2. Power management unit 202 also provides power and receives data back from three axis magnetometer 132A, three axis gyro 132B and three axis accelerometer 132C. Power management unit 202 also provides power and receives data back from and sends data to GPS transceiver 144.

FIG. 3B is a block diagram of one embodiment of the hardware and software components of a processing unit 4 associated with a see-through, near-eye, mixed reality display unit. FIG. 3B shows control circuit 304 in communication with power management circuit 306. Control circuit 304 includes a central processing unit (CPU) 320, graphics processing unit (GPU) 322, cache 324, RAM 326, memory control 328 in communication with memory 330 (e.g., D-RAM), flash memory controller 332 in communication with flash memory 334 (or other type of non-volatile storage), display out buffer 336 in communication with see-through, near-eye display device 2 via band interface 302 and band interface 232, display in buffer 338 in communication with near-eye display device 2 via band interface 302 and band interface 232, microphone interface 340 in communication with an external microphone connector 342 for connecting to a microphone, PCI express interface for connecting to a wireless communication device 346, and USB port(s) 348.

In one embodiment, wireless communication component 446 can include a Wi-Fi enabled communication device, Bluetooth communication device, infrared communication device, cellular, 3G, 4 G communication devices, wireless USB (WUSB) etc. The wireless communication component 446 may use antenna 225 for peer-to-peer data transfers with for example, another display device system 8, as well as connection to a larger network via a wireless router or cell tower. The USB port can be used to dock the processing unit 4 to another display device system 8. Additionally, the processing unit 4 can dock to another computing system 12 in order to load data or software onto processing unit 4, as well as charge processing unit 4. In one embodiment, CPU 320 and GPU 322 are the main workhorses for determining where, when and how to insert virtual images into the view of the user.

Power management circuit 306 includes clock generator 360, analog to digital converter 362, battery charger 364, voltage regulator 366, see-through, near-eye display power source 376, and temperature sensor interface 372 in communication with temperature sensor 374 (located on the wrist band of processing unit 4). An alternating current to direct current converter 362 is connected to a charging jack 370 for receiving an AC supply and creating a DC supply for the system. Voltage regulator 366 is in communication with battery 368 for supplying power to the system. Battery charger 364 is used to charge battery 368 (via voltage regulator 366) upon receiving power from charging jack 370. Device power interface 376 provides power to the display device 2.

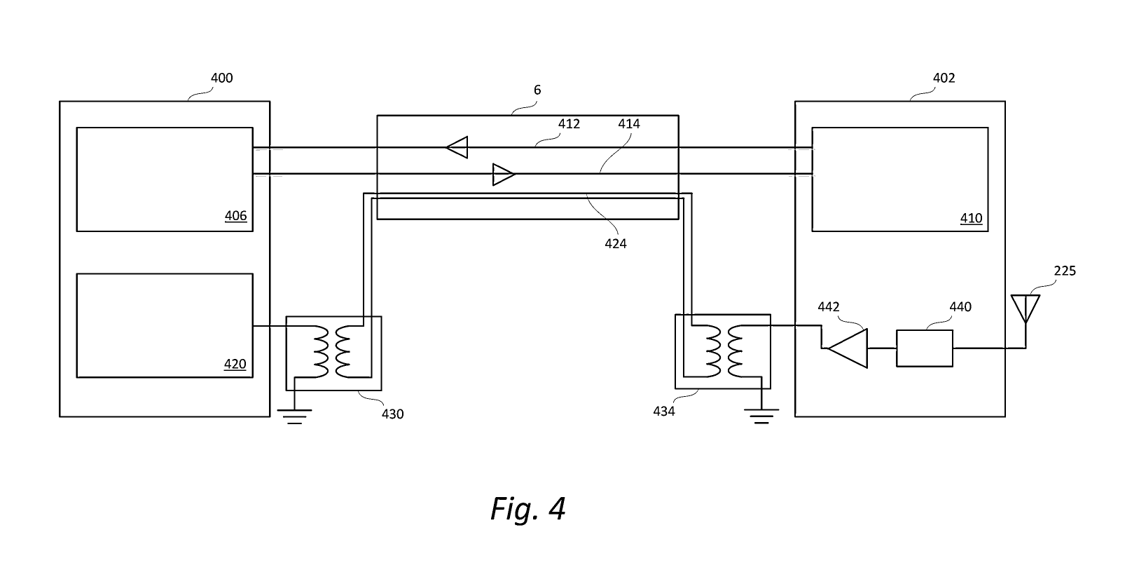

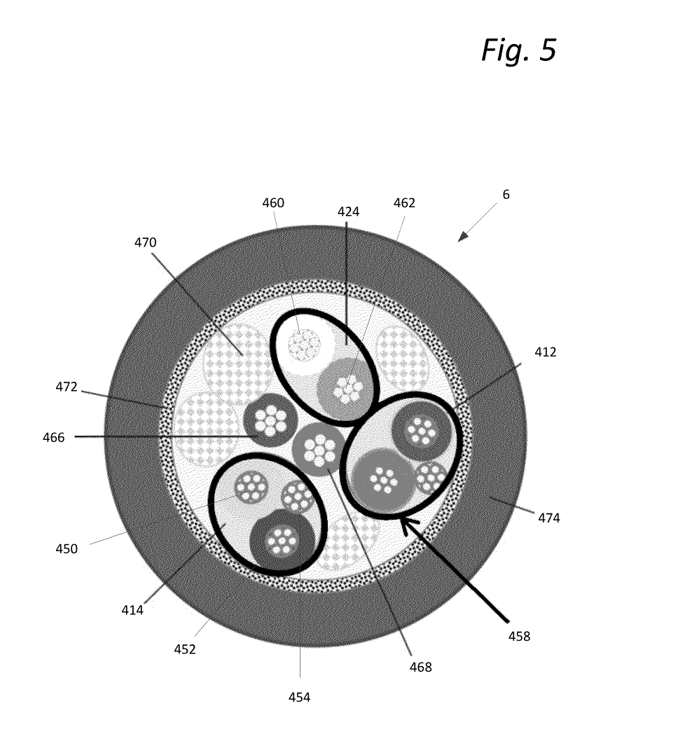

In the above-described example, both analog and digital signals are communicated between the head mounted display 2 and the processing unit 4. Moreover, high speed digital and analog signal and data transfer is important to ensure coordination of virtual images with real world images. In order to accomplish this data and signal transfer, cable 6 may have a novel configuration which will now be explained with reference to FIGS. 4 and 5.

FIG. 4 shows a generalized communication block diagram of a first component 400 operatively coupled to a second component 402 via the cable 6 shown in FIG. 1. First component 400 may for example be processing unit 4 and the second component 402 may for example be head mounted display 2. However, it is understood that the components 400 and 402 may be any components of a distributed antenna system where an antenna in component 402 is spatially separated from an analog transceiver in component 400.

Cable 6 may be used to transfer a high-speed, baseband digital signal between a processor 406 in component 400 and a processor 410 in component 402. Processor 406 may for example be CPU 420 (FIG. 3B) in the processing unit 4, and processor 410 may for example be processor 210 (FIG. 3A) in head mounted display 2, but as indicated, they may be processors in other components as well. The high speeds are accomplished in part by having two separate signal-carrying lines 412, 414, one used for transmitting and the other used for receiving, for example, to support dual simplex SuperSpeed digital signaling in accordance with the Universal Serial Bus (USB) 3.0 architecture. Each of the lines 412, 414 may be a shielded differential pair (SDP), as explained in greater detail below with reference to FIG. 5.

Cable 6 further includes a signal-carrying line 424 for carrying RF or other analog signals between a transceiver 420 in component 400 and an antenna 225 in component 402. In embodiments, the RF line 424 may carry a variety of signals including for example low band cellular, GPS, high band cellular and 802.11 wireless networks as non-limiting examples. These signals are transferred at frequencies of up to 6 GHz, though the maximum frequency may be higher or lower than that in further examples. With these signals, the RF line 442 may operate at frequencies of, for example 700 MHz to 6 GHz, though the operational frequency within line 424 may be above and/or below this range in further embodiments.

At these data rates and frequencies, the RF line 424 is particularly susceptible to cross-talk from the high-speed digital lines 412, 414. As such, conventional micro-co-axial cable with conventional shielding may be largely ineffective at reducing noise and providing the required receiver sensitivity performance from the RF line 424. In order to reduce the effects of cross-talk from the digital baseband lines 412, 414, RF line 424 may be a balanced signal SDP so that noise between the wires in the SDP is largely canceled out between the wire pair. Further details of the RF line 424 are explained below with reference to FIG. 5.

As signals from transceiver 420 and antenna 225 are unbalanced, and the signals through the SDP RF line 424 are balanced, transformers such as baluns 430 and 434 may be provided to enable delivery over the pair of wires forming line 424. In one example, the baluns 430, 434 may be packages that surface-mount to printed circuit boards in the transceiver 420 and component 402, respectively In embodiments, the baluns 430 and 434 may be identical to each other, and manufactured for example under model number B0430J50100A00 from Anaren, Inc., having offices in East Syracuse, N.Y. Custom baluns and baluns from other manufacturers are also contemplated. The baluns are provided as wide-band baluns, for example handling frequencies from 700 MHz to 6 GHz to cover the range of frequencies used on line 424.

In embodiments, the baluns 430, 434 may connect via electrical traces in their respective PCBs to receptacles on the PCBs for receiving connectors on opposite ends of cable 6. Each receptacle/connector pair may be a known USB connection interface, such as for example USB3.0 A receptacle and connector, or USB3.0 micro-B receptacle and connector. Other receptacle/connector interfaces are contemplated. In an alternative embodiment, instead of being mounted to a PCB, one or both of the baluns may be integrated into cable 6, adjacent to or formed as part of the cable connector.

In operation, RF signals are picked up by antenna 225, and filtered through a filter 440 that attenuates unwanted frequency content, for example frequencies below or above some defined threshold (such as frequencies below 700 MHz and above 6 GHz, though it may vary outside of this range in further examples). The signal then passes through low noise amplifier 442 for amplifying the possibly low signal received by antenna 225. The unbalanced RF signal then passes through balun 434 to provide a balanced RF signal through line 424 of cable 6. At the component 400, the balanced signal is again transformed into an unbalanced signal by balun 430 at transceiver 420. Thereafter, the signal may be processed, transferred or otherwise acted on by processor 406 in component 400. Signals may alternately travel from transceiver 420 for transmission by antenna 225 via RF line 424 in a similar manner. Simultaneously with this RF signal transfer, high-speed digital signals are transferred between components 400 and 402 via lines 412, 414.

FIG. 5 is a cross-section through cable 6 showing the lines and elements within cable 6. The make-up of the interior of cable 6 is uniform along its length, and the cross-section of FIG. 5 may be taken at any position along cable 6 (short of the connection plugs at the ends of the cable). FIG. 5 shows the interior of the SDP digital baseband lines 412, 414. Each line 412, 414 has the same composition, and includes a pair of wires 450, 452 (marked only on line 414) individually wrapped in a plastic or polymer such as for example polyvinyl chloride (PVC). The wires may be wrapped in other materials in further embodiments.

Each of the wires 450, 452 within lines 412, 414 may themselves be composed of a plurality of strands or a single strand of metal, such as for example copper, optionally plated with for example tin. The wires 450, 452 may be formed of other materials and optionally plated with other materials in further embodiments. The wires 450, 452 may for example be 26-34 wire gauge, AWG, though the wire gauge may vary above and below that range in further embodiments.

Each of the lines 412, 414 may further include a drain wire 454 (marked only on line 414), which is eventually connected to the system ground through a connector plug at the end of the cable 6. The drain wires 454 may for example be 28-34 gauge copper, AWG, but may be thicker or thinner than that in further embodiments. Instead of SDP, one or both of the digital lines 412, 414 may be formed of twisted or twinax signal pairs in further embodiments.

The RF line 424 may include a pair of wires 460, 462 individually wrapped in a plastic or polymer such as for example PVC. The wires may be wrapped in other materials in further embodiments. Each of the wires 460, 462 within line 424 may be composed of a plurality of strands or a single strand of metal, such as for example copper, optionally plated with for example tin. The wires may be formed of other materials and optionally plated with other materials in further embodiments. The wires 460, 462 may for example be 26-34 wire gauge, AWG, though the wire gauge may vary above and below that range in further embodiments. Instead of SDP, the RF line 424 may be formed of twisted or twinax signal pairs in further embodiments.

Forming the RF line 424 of a pair of wires such as SDP carrying differential signals aids in reducing noise in the RF line at the working frequencies. However, further noise reduction is achieved by providing a jacket 458 around each of the lines 412, 414 and 424 (only line 412 is marked) formed of a ferrite absorber extruded over the length of each line 412, 414 and 424. The extrusion may be formed from ferrite pellets that are extruded over the length of the lines 412, 414 and 424. The ferrite jackets absorb noise and other electromagnetic interference (EMI).

The ferrite jacket 458 encases each of the lines 412, 414 and 424 along the entire length of each of the lines, and 360° around the circumference of the lines. In embodiments the jackets 458 around the respective lines may each have a thickness of 0.1 mm, though the thickness of the jackets 458 may be thinner or thicker than that in further embodiments. Instead of extruded ferrite, the jackets 458 may alternatively be formed of another EMI absorbing material, such as for example Silicon Carbide, carbon nanotube, Magnesium Dioxide and other materials. Moreover, instead of extruding, the EMI absorbing material may be applied to lines 412, 414 and/or 424 as a film, or provided as a woven or braided jacket.

In the above-described embodiment, each of the lines 412, 414 and 414 is encased in an EMI-absorbing jacket such as ferrite. However, it is understood that the lines 412 and 414 may have an EMI-absorbing jacket, and the line 424 may have a conventional jacket of plastic or polymer, such as PVC. Alternatively, the RF line 424 may have an EMI-absorbing jacket, and the lines 412, 214 have a conventional jacket of plastic or polymer, such as PVC.

The interior of cable 6 further includes power and ground lines 466 and 468. The power and ground lines 466, 468 may for example be 20-28 gauge copper, AWG, but may be thicker or thinner than that in further embodiments. The interior may further include dielectric filler 470 (one of which is marked in FIG. 5), though the filler 470 may be omitted in further embodiments. The lines 412, 414 and 424, together with the other elements within cable 6, may all be encased in a metal braid 472, which may in turn be encased within an outer jacket 474.

The electrical properties of cable 6 may be those of a USB3.0 cable, set forth for example in the Universal Serial Bus 3.0 Specification, Revision 1.0, Jun. 6, 2011, which specification is incorporated herein by reference. The differential characteristic impedance for the SDP lines 412, 414 and 424 may each be within 90Ω+/−7Ω, as measured with a time-domain reflectometer (TDR) in a differential mode using a 200 ps (10%-90%) rise time. The intra-pair skew for the SDP lines 412, 414 and 424 may be less than 15 ps/m, as measured with time domain transmission (TDT) in a differential mode using a 200 ps (10%-90%) rise time with a crossing at 50% of the input voltage. The above electrical properties are by way of example only and may vary in further embodiments. Other electrical properties may be as set forth in the standard for USB3.0 cables. The length of the cable 6 may vary in embodiments, but may for example be 1 to 5 meters in length, and 2 to 4 meters in length in a further example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A cable for transferring digital and analog signals between a first component including a transceiver and a second component including an antenna, the second component remote from the first component, the cable comprising:
a pair of digital lines for carrying digital baseband signals between the first and second components;
an analog line for carrying signals between the antenna and the transceiver at operating frequencies between 700 MHz and 6 GHz, the analog line including a pair of wires carrying common mode analog signals; and
a pair of wideband baluns, coupled to ends of the analog line, for transforming the signals to enable delivery over the pair of wires of the analog line, the wideband baluns capable of transforming the signals over the operating frequencies between 700 MHz and 6 GHz.

2. The cable recited in claim 1, wherein the analog line is encased in an electromagnetic interference-absorbing jacket.

3. The cable recited in claim 2, wherein the electromagnetic interference-absorbing jacket is a ferrite jacket.

4. The cable recited in claim 2, wherein the electromagnetic interference-absorbing jacket is a jacket formed of one of Silicon Carbide, carbon nanotube and Magnesium Dioxide.

5. The cable recited in claim 2, wherein the electromagnetic interference-absorbing jacket is an extruded metal jacket.

6. The cable recited in claim 1, wherein the pair of wires of the analog line are a differential pair of signal wires.

7. The cable recited in claim 1, wherein the pair of wires of the analog line are a twisted pair of signal wires.

8. The cable recited in claim 1, wherein the pair of wires of the analog line are a twinax pair of signal wires.

9. The cable recited in claim 1, wherein the pair of digital lines each include a differential pair of signal wires.

10. The cable recited in claim 1, further comprising power and ground wires within the cable.

11. A cable for transferring digital and analog signals between a first component including an RF transceiver and a second component including an antenna, the second component spatially separated from the first component, the cable comprising:
a pair of digital lines for carrying digital baseband signals between the first and second components, a first digital line of the pair of digital lines carrying signals from the first component to the second component, and a second digital line of the pair of digital lines carrying signals from the second component to the first component;
an RF line for carrying RF signals between the antenna and the RF transceiver at operating frequencies between 700 MHz and 6 GHz, the analog line including a differential pair of signal wires carrying differential analog signals, the RF line encased in an electromagnetic interference-absorbing jacket; and
a pair of wideband baluns, coupled to ends of the RF line, for transforming the signals to enable delivery over the differential pair of signal wires, the wideband baluns capable of transforming the signals over the operating frequencies between 700 MHz and 6 GHz.

12. The cable recited in claim 11, wherein the RF line and wideband baluns support analog signals used for low band cellular, gps, high band cellular and 802.11 wireless networks.

13. The cable recited in claim 11, wherein the pair of digital lines are also encased in electromagnetic interference-absorbing jackets.

14. The cable recited in claim 13, wherein the electromagnetic interference-absorbing jackets around the RF and digital lines are jackets formed of one or more of ferrite, Silicon Carbide, carbon nanotube and Magnesium Dioxide.

15. The cable recited in claim 13, wherein the electromagnetic interference-absorbing jackets around the RF and digital lines are jackets formed of one or more of an extrusion, a film and a braid.

16. The cable recited in claim 11, wherein the pair of baluns are packages for surface mounting to a printed circuit board of the first and second components.

17. A cable for transferring digital and analog signals between a processing unit including an RF transceiver and a head mounted display device including an antenna in a see-through augmented reality system, the processing unit spatially separated from the head mounted display device, the cable comprising:
a pair of digital lines for carrying digital baseband signals between the processing unit and the head mounted display device, a first digital line of the pair of digital lines carrying signals from the processing unit to the head mounted display device, and a second digital line of the pair of digital lines carrying signals from the head mounted display device to the processing unit, the pair of digital lines encased in ferrite jackets;
an RF line for carrying RF signals between the antenna and the RF transceiver at operating frequencies between 700 MHz and 6 GHz, the analog line including a differential pair of signal wires carrying differential analog signals, the RF line encased in a ferrite jacket; and
a pair of wideband baluns, coupled to ends of the RF line, for transforming the signals to enable delivery over the differential pair of signal wires, the wideband baluns capable of transforming the signals over the operating frequencies between 700 MHz and 6 GHz.

18. The cable recited in claim 17, wherein the RF line and wideband baluns support analog signals used for low band cellular, gps, high band cellular and 802.11 wireless networks.

19. The cable recited in claim 17, wherein the cable is between 1 to 5 meters in length.

20. The cable recited in claim 17, wherein the ferrite is extruded from ferrite pellets.
